(19) United States
(12) Patent Application Publication
(10) Pub. No.: US 2014/0214583 A1
(43) Pub. Date: Jul. 31, 2014

(54) DATA DISTRIBUTION SYSTEM, METHOD AND PROGRAM PRODUCT

(71) Applicant: INTERNATIONAL BUSINESS MACHINES CORPORATION, Armonk, NY (US)

(72) Inventors: Marcos Dias De Assuncao, Sao Paulo (BR); Timothy Lynar, Kew (AU); Marco Aurelio Stelmar Netto, Sao Paulo (BR); Kent Steer, Brunswick (AU); Christian Vecchiola, Southbank (AU)

(73) Assignee: International Business Machines Corporation, Armonk, NY (US)

(21) Appl. No.: 13/751,856

(22) Filed: Jan. 28, 2013

(51) Int. Cl. G06Q 30/08

(52) U.S. Cl. CPC G06Q 30/08
USPC 705/26.3

(57) ABSTRACT

A data distribution system, method and a computer program product therefor. Computers share resources with organizations in multiple locations. At least one selling agent supports organizations in each location. The selling agent placing offers to sell selected organizational data in an auction marketplace. At least one buying agent supports organizations in said each location. The buying agent selectively places bids responsive to offers to sell data and. A data discovery service provisioned on the computer(s) identifies potential buyers of organizational data and notifies respective buying agents of data available from other organizations.

### BACKGROUND OF THE INVENTION

1. Field of the Invention

The present invention is related to sharing locally generated data among organizations in other locations and more particularly to more efficiently distribute collected/generated data for one location with other locations that may otherwise be unaware of, but that may have a need or use for, the data.

2. Background Description

A typical broad geographic area may cover many smaller locations, each managed and serviced by local authorities, e.g., organizations, government departments, and individuals. Local authorities are setting up operation centers, such as the IBM Intelligent Operations Center, to efficiently monitor and manage services for the location, e.g., police, fire departments, traffic management and weather. See, e.g., www-01.ibm.com/software/industry/intelligent-oper-center/.

A state of the art operation center includes an emergency capability that facilitates proactively addressing local emergencies. In particular, the operation center emergency capability facilitates departments in generating, collecting, and processing voluminous information about the local environment from a range of location services and simulation engines. Sources of this information include, for example, police department, fire departments, traffic management systems, weather forecasts, and flooding simulation. The usefulness of much of this data produced, processed and collected by one entity may overlap with, be common with, and frequently is relevant to, not only other local organizations, but also to organizations in one or more of the other (e.g., surrounding) local entities.

A typical operation center normally simulates and models local conditions and extreme weather conditions, e.g., traffic, weather and flooding in metropolitan areas. By combining local sensor data with the simulation results the operation center can identify possible infrastructure disruptions. After using the simulation results to identify potential disruptions, the operation center can identify similar conditions as they arise, and trigger appropriate local responses, e.g., initiate processes to circumvent and/or minimize effects of the disruptions. Thus, the simulation and model results have made an operation center an important tool in minimizing the impact of flooding and, moreover, for flood prevention planning in highly populated areas. Similarly, a typical operation center uses simulation and model data to facilitate situational planning for dry regions, e.g., to mitigate bush fire damage to crops.

A complete data picture is key to analyzing and predicting the potential impact of extreme or hazardous conditions for a specific locale. While, a typical simulation may focus on a small, limited area, the results generally depend on data from a more widespread region and surroundings. Simulating extreme weather conditions, for example, a hurricane impacting a city, requires data from surrounding, and even distant locations. Locating and identifying all relevant data that may be available, has not been a simple task.

Thus, there is a need for discovering available geography specific data and in particular for facilitating allowing owners of geography specific data cost sharing, and optimization of the production of geography specific data.

### SUMMARY OF THE INVENTION

A feature of the invention is more efficient sharing of data collected/generated by an organization with and among, other interested organizations, with an interest in the data;

Another feature of the invention is distribution of collected/generated data reactively and proactively;

Yet another feature of the invention is collecting/generating data in a more efficient distribution, and sharing the data between organizations in different locales, based on the need to each organization.

The present invention relates to a data distribution system, method and computer program product therefor. Computers share resources with organizations in multiple locations. At least one selling agent supports organizations in each location. The selling agent placing offers to sell selected organizational data in an auction marketplace. At least one buying agent supports organizations in said each location. The buying agent selectively places bids responsive to offers to sell data and. A data discovery service provisioned on the computer(s) identifies potential buyers of organizational data and notifies respective buying agents of data available from other organizations.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIGS. 4A-B show an example of a preferred system servicing organizations in neighboring locales, share geographically specific data according to a preferred embodiment of the present invention;

FIG. 5 shows an example of data sharing using a preferred system;

FIG. 6 shows an example of pseudo-code for a suitable bidding strategy for a buying agent;

FIG. 7 shows an example of proactively publishing and marketing collected data for running more refined experiments, e.g., by a data discovery service in shared system resources;

FIG. 8 shows an example of pseudo-code for selectively adjusting the experiment queue of based on the urgency that other organizations may give to certain experiments and data in the queue.

### DESCRIPTION OF PREFERRED EMBODIMENTS

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed and as further indicated hereinbelow.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

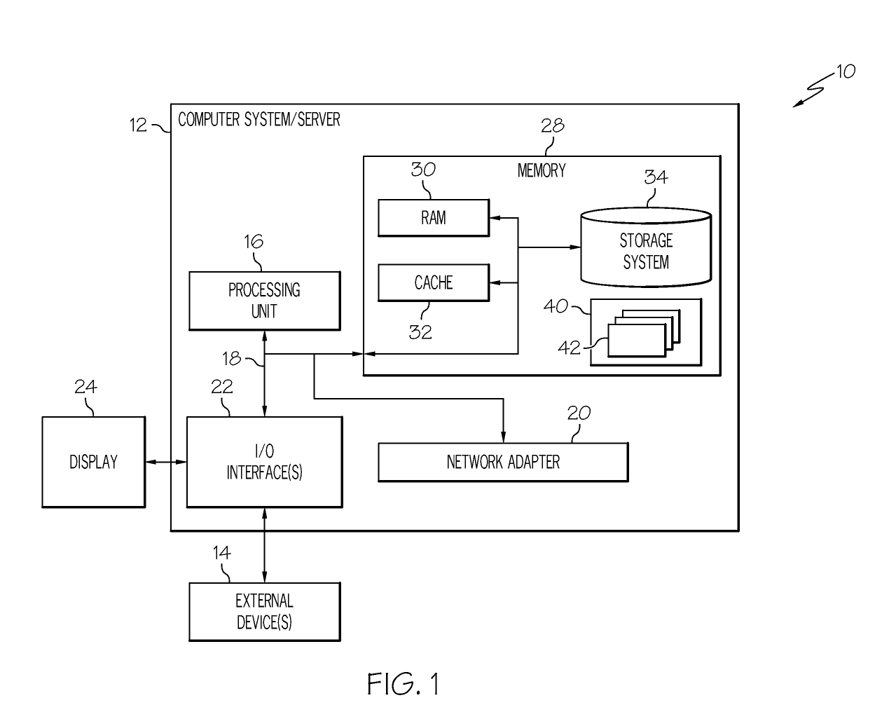

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

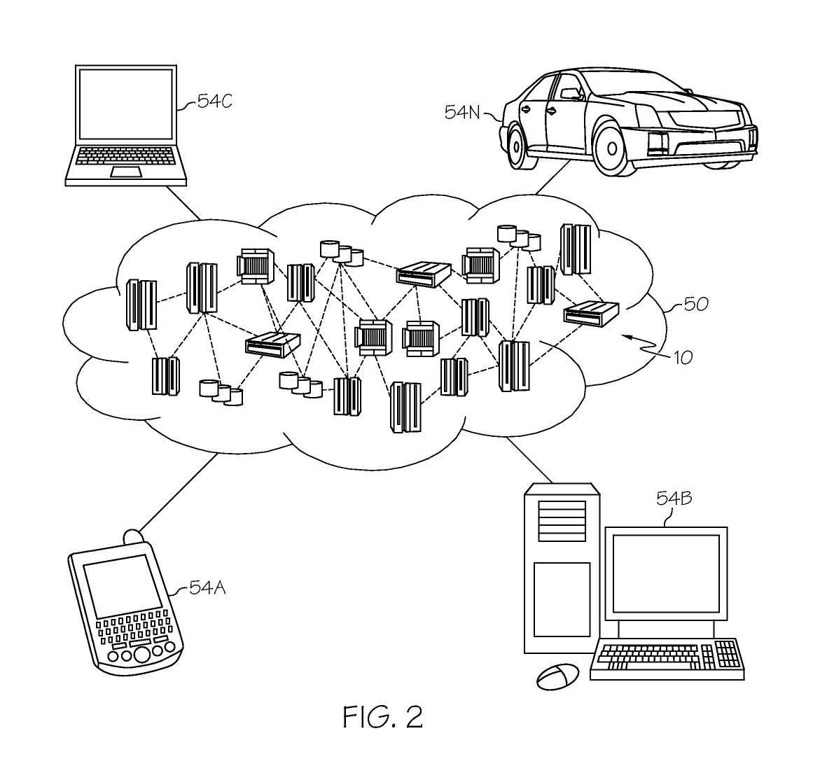

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

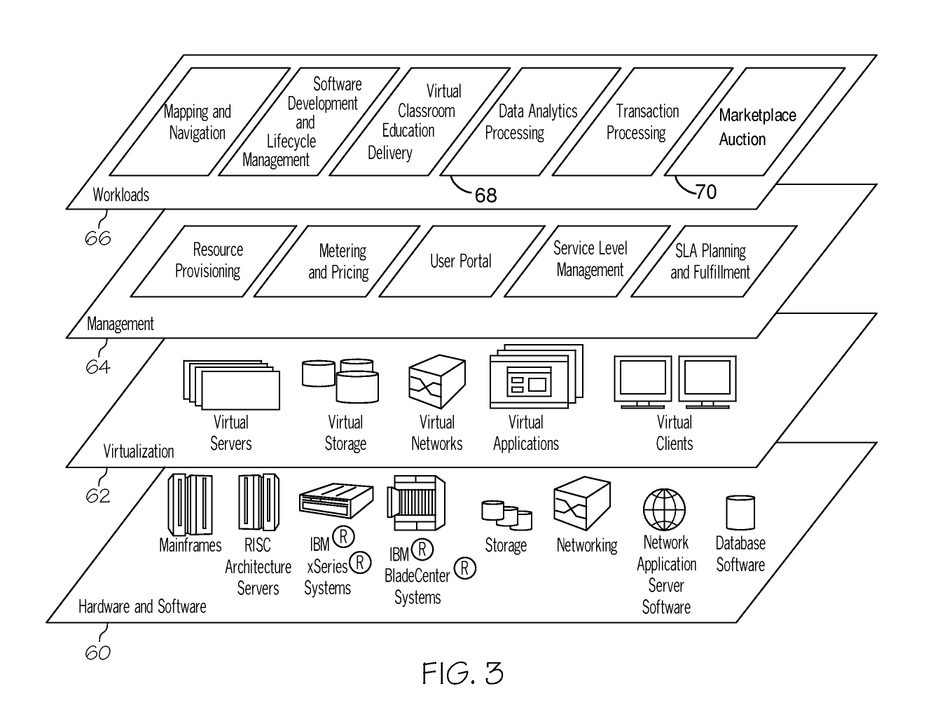

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing 68; transaction processing; and marketplace auction 70.

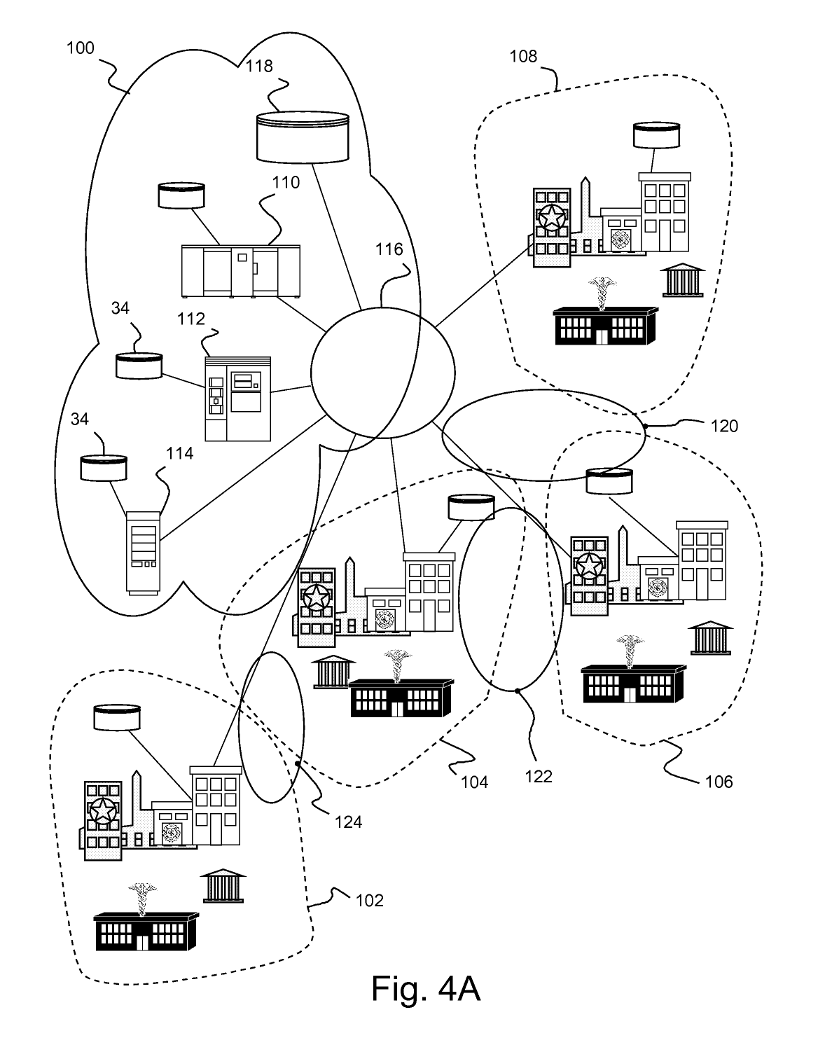

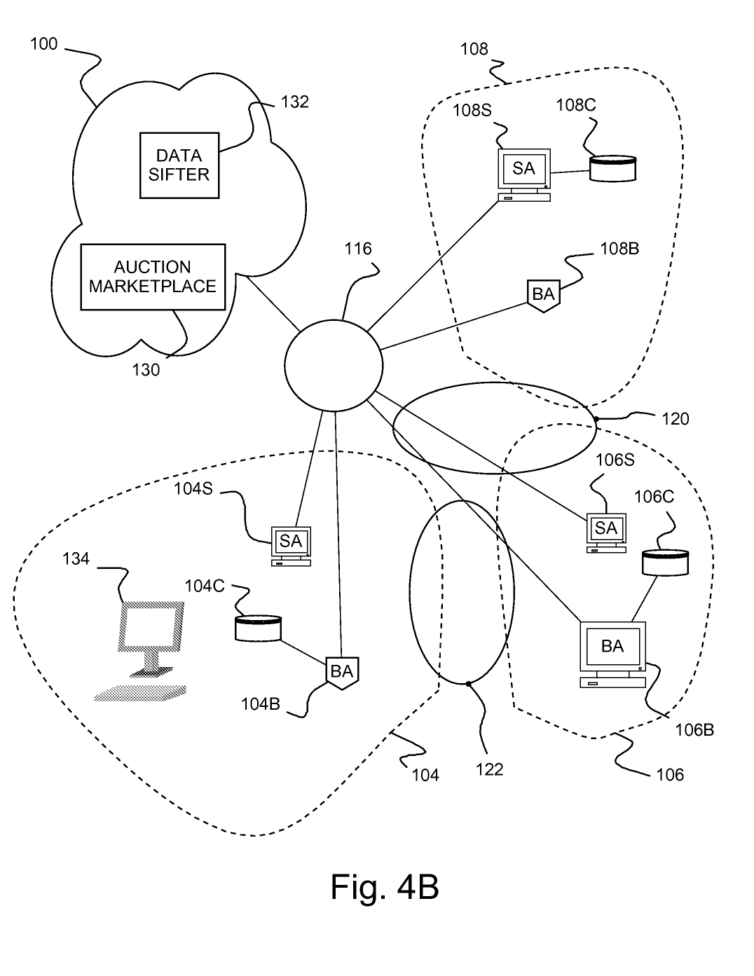

FIGS. 4A-B show an example of a preferred system 100 distributing and sharing data according to a preferred embodiment of the present invention. Organizations servicing neighboring locales 102, 104, 106, 108, clients of one or more system computers 110, 112, 114 connected to network 116, share geographically specific data, collected or generated and stored e.g., in local storage 34 or in network attached storage (NAS) 118. Locale 102, 104, 106, 108 inhabitants, organizations (public and private) and individuals, produce data that is specific to a particular geographic region, i.e., the respective locale 102, 104, 106, 108. However, the preferred system 100 facilitates sharing and distributing data for a locale, beyond the locale to which it directly pertains to other locales that have a need for the data, especially when local organizations are not previously aware of any need for the data.

While the individual organizations are generally interested in data from very specific geographical regions or locales 102, 104, 106, 108, frequently, far reaching events occur that cause interest to the location data to expand beyond the particular locales 102, 104, 106, 108. Moreover, the interest in an event arising in one locale 102, 104, 106, 108 may expand into overlapping regions 120, 122, 124 such that neighboring locales become concerned. Consequently, for these overlapping regions 120, 122, 124 the local service organizations may be replicating responses and services.

For example, the locale 102, 104, 106, 108 organizations may have an interest in acquiring local wind energy data. However, wind is not constricted by boundaries. So, such data typically contains information or forecasts on the wind conditions of a region beyond the locale boundaries. Other organizations can use the forecasts to estimate how much energy the regional winds produce over a given period. Using a preferred system 100, locale 102, 104, 106, 108 organizations can make a guided exchange of acquired forecast data for overlapping areas 120, 122, 124, selling and buying based on shared interest, e.g., simulation results projecting traffic condition for large metropolitan areas.

Since geographic data is generally time dependent, time specific, geographically specific, output type and resolution specific and application specific, it may tend to grow stale. The respective organizations attach different values to data depending on the local need for it, where the need, and correspondingly, value, can change over time. The organizations also apply different trust to data from a given source, and the cost of alternative data. For example, in an extreme weather condition emergency, one organization may place a high value on specific geographic data, e.g., from a trusted source, of a particular type, resolution and for a certain region. Moreover, the acquiring organization may limit that value (i.e., what it is willing to spend) to a very specific time window.

Accordingly, the preferred system 100 uses a combined proactive and reactive, economic model-based distribution to non-exclusively facilitate allocating and sharing newly generated and collected data, and in a timely manner, using an auction type approach, for example, for selling and buying fresh data. Organizations reactively run experiments to produce data and offer the results for sale to other organizations.

Proactively, as organizations are informed of available data, the organizations perform preliminary experiments to estimate potential savings, e.g., based on the time that would be required to generate the data from scratch, the execution time for running refined experiments on the data, and the importance of the data. Based on the results, each organization may publish an interest in acquiring the data from other organizations.

The preferred economic model-based distribution facilitates disseminating and sharing collected data with, and acquiring data from, organizations that most value regardless of geographical location. In particular, if an organization(s) in one locale e.g., 104, is producing data that can be reused and that may be of interest to organizations in others 102, 106, 108, the event data is allocated and disseminated to those organizations with the highest interest and most urgent need as measured by their willingness to pay for it. It should be noted that the present invention has particular advantage for sharing data across organizations in multiple locales and using the same information technology (IT) infrastructure, where sharing data may be beneficial and more efficient to the IT provider, where sharing eases resource provisioning.

The preferred system 100 typically considers several data characteristics in projecting data importance to the potential recipient. Data characteristics can include, for example, geography, execution time of any preliminary experiments performed in generating the data, and any expiration date, i.e., any deadline for consuming the data. Furthermore, with data collection and dissemination as clients (both data collector clients and data recipients) identify, and better appreciate, what data is more important, the system 100 refines an importance measure applied to the data.

As shown in the operational example of FIG. 4B for locales 104, 106, 108, the system markets data collected in one locale using a continuous double auction, where an originating seller asks a starting price (an ask) for data items and buyers in other locales submit bids. Preferably, the age of the data is explicitly stated in the description of the auction item. Asks and bids are open (as opposed to closed bids or closed asks) and both have explicit expiry times.

Individual organizations may own a local data cache 104C, 106C, 108C with location Buying Agents (BAs) 104B, 106B, 108B acquiring data from, and Selling Agents (SAs) 104S, 106S, 108S selling data to, other organizations, locally in the same area, e.g., 104, or in other locales 102, 106, 108. The preferred system 100 includes a provisioned auctioneer or auction marketplace 130 (e.g., marketplace auction 70 in FIG. 3) and a data discovery based service 132 (e.g., data analytics processing 68) based on, for example, a multi-attribute publish/subscribe mechanism. Further, each locale may have a simulation capability 134, locally running simulations or using provisioned resources for simulations (also, data analytics processing 68), and used by the location buying agents 104B, 106B, 108B and selling agents 104S, 106S, 108S.

Although in this example the organizations in locales 102, 104, 106, 108, are shown as distinct entities hosted on the same shared IT infrastructure, e.g., a cloud, the present invention has application to resources distributed across multiple such IT infrastructure or clouds shared by organizations servicing a single or multiple locales. Also in this example, the buying agents 104B, 106B, 108B, selling agents 104S, 106S, 1085, auctioneer/auction marketplace 130 and a discovery service 132 are hardware, or software applications running in hardware, autonomously, interactively or semi-interactively.

Preferably, each organization provides the buying agents 104B, 106B, 108B with a private valuation of each given datum, piece of data or data collection. Typically, the valuation for the organization(s) is(are) based on the need for the data, the data characteristics and a trust value assigned to the data. The particular buying agent 104B, 106B, 108B determines the value using, criteria for an organization including: data production cost, data production time, and projected future value. Data production cost is the cost of using organization resources to produce the same data as opposed instead to acquiring it, e.g., purchasing it from the selling agent or another selling agent. The data production time includes the time organizational resources would require to produce the data. The projected future value is important where the organization may not have a present need, but projects a future need of the data. Thus, the future value may be projected by considering that the value of data often decays with time and offsetting the estimated cost of producing it in the future. Further, although organizations can provide each buying agent 104B, 106B, 108B with a bidding strategy, preferably, the above criteria are included in the bidding strategy before receiving data.

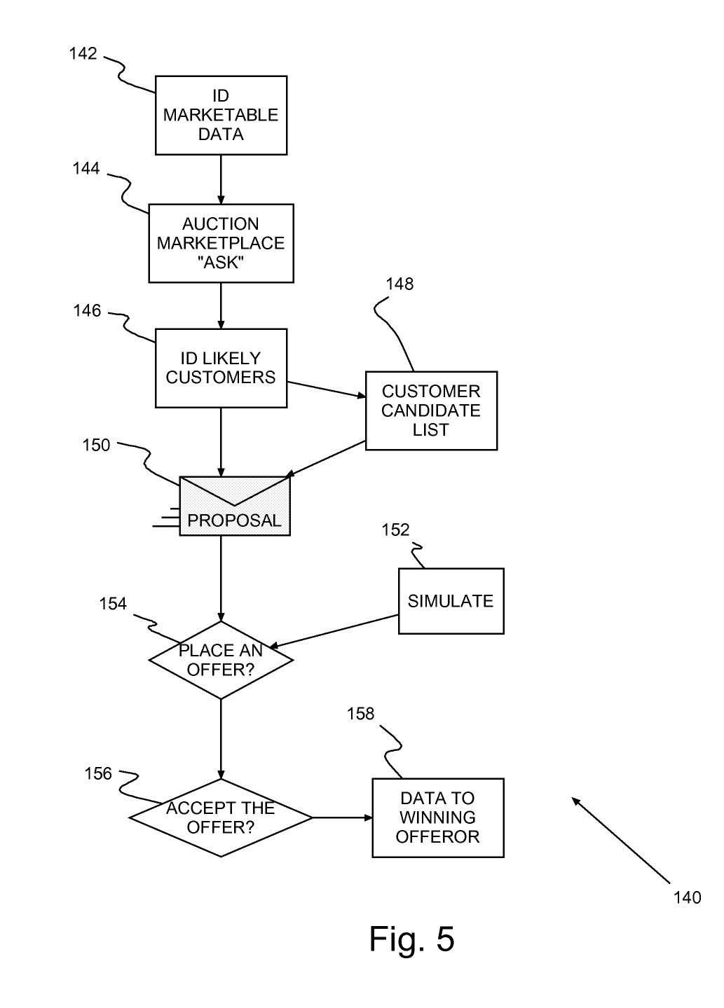

FIG. 5 shows an example of data sharing 140 using a preferred system 100 according to a preferred embodiment of the present invention with reference to FIGS. 4A-B. First an organization selling agent, e.g., SA 108S in locale 108, identifies new data 142 that its organization has produced, e.g., in a file or a dataset, that might be useful to other locales/organizations. A location may have multiple new files or datasets, for example, with the local selling agent determining which data may be useful to other organizations. Having made that determination, the selling agent 1085 places an ask 144 on the auction marketplace 130, announcing the organization's interest in selling the data.

The auctioneer 130 uses the discovery service 132 to sift through the data and identify 146 organizations potentially interested in the data. The discovery mechanism or service 132 returns 148 a list of candidate customers for the data. Then, proposals are sent 150 to the listed candidate buying agents, e.g., 104B, 106B, e.g., automatically by the auctioneer 130, for example, or by the selling agent 108S. In another locale, e.g., 104, the buying agent BA 104B runs a simulation 152 to decide whether to place an offer 154. The auction may be an ascending price auction, a descending price auction, or a second price auction. The auction completes or clears 156 when a bid exceeds or equals an ask. The winning bidder receives 158 the dataset from originating locale 104, e.g., using a suitable data transfer protocol such as file transfer protocol (FTP) or hypertext transfer protocol HTTP.

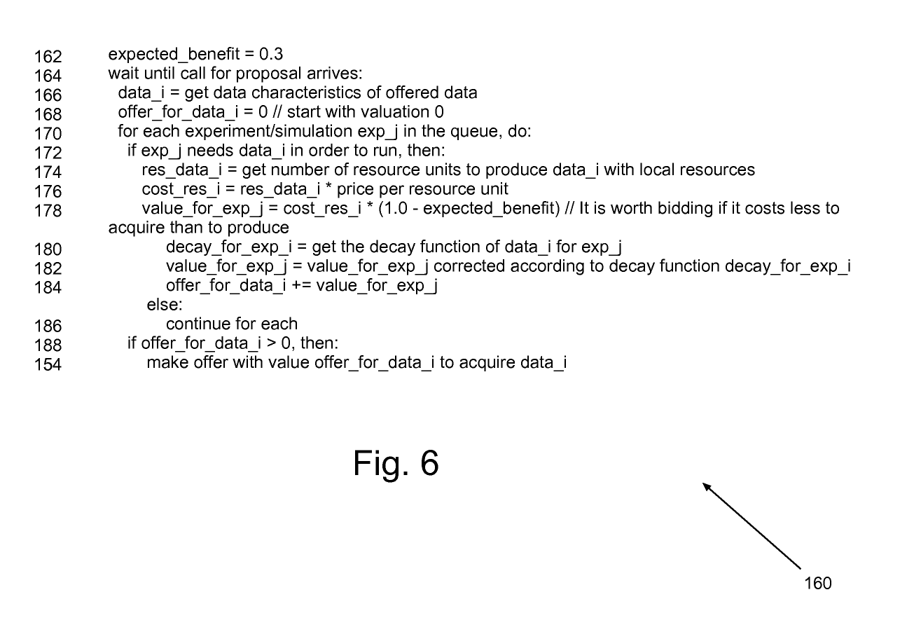

FIG. 6 shows an example of pseudo-code for a suitable bidding strategy 160 for a buying agent, e.g., 104B, 106B, 108B in FIG. 4B with reference to the method of FIG. 5. In this example, an expected benefit parameter 162 determines a minimum savings for acquired data as opposed to producing it originally with local resources. The buying agent 104B, 106B, 108B waits 164 until a proposal (150 in FIG. 5) arrives. When a proposal 150 arrives the agent initializes data variables 166 to the values in the proposal, and initializes a cumulative offer value 168, e.g., sets it to zero. Then, the agent begins 170 checking the data for suitability in experiments/simulations for the particular organization(s). If an experiment/simulation 152 requires the data to run 172; then, the agent estimates resources 174 to produce the data, and the cost of the estimated resources is determined 176. From this cost the agent determines 178 the value of acquiring the data, where the higher the cost, the more efficient it is to acquire the data than produce it, i.e., acquiring it yields savings in excess of the minimum expected benefit.

Even if the benefit of acquiring the data currently exceeds the minimum expected benefit, if the data is not intended for immediate use, but for some future time, the agent offsets the offer for aging the data. So, the agent determines 180 a decay rate on the loss in data value with age, and then, calculates the loss in value 182 by the expected time of use. The agent adjusts the cumulative offer value 184 by the expected cost offset by depreciation loss. If any experiments/simulations remain that may use the data, the agent continues 186 checking 170 the data for suitability. After costing the data for all experiments/simulations, if no simulations use the data, the resulting value remains zero. Otherwise, if the cumulative offer value is positive 188, the buying agent returns an offer 154, using an expected benefit of at least 0.3 in this example, the offer generally is set to save at least 30% for acquiring the data over the projected cost to locally produce and use the data.

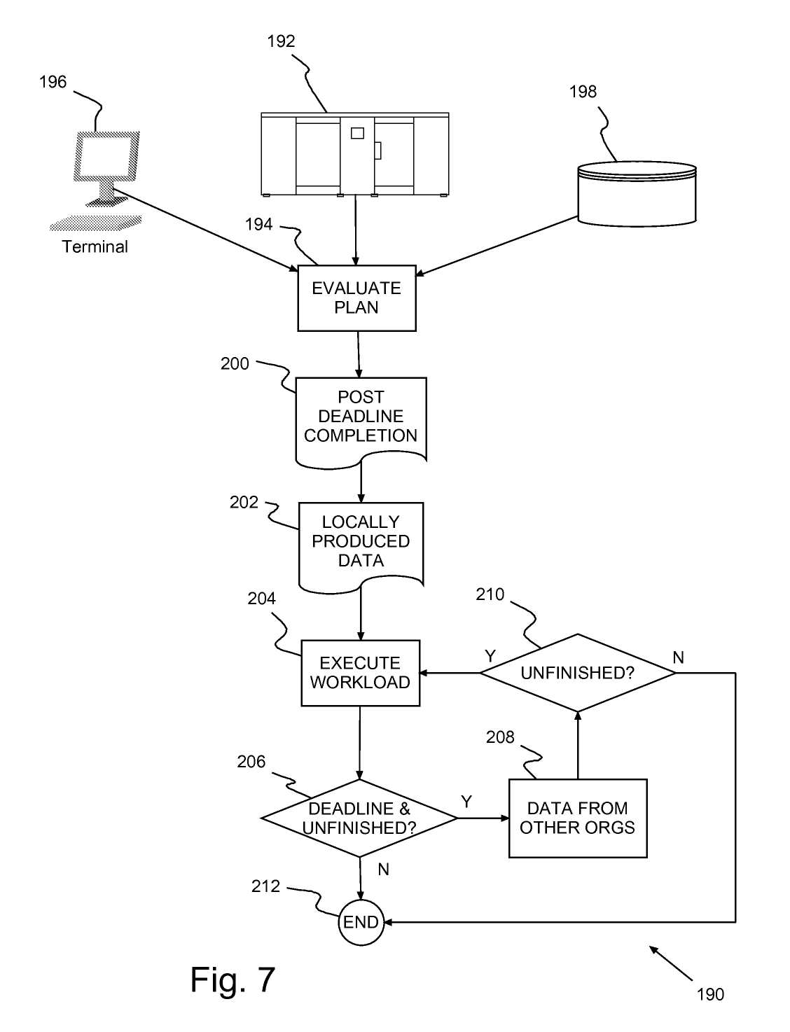

FIG. 7 shows an example of proactively publishing and marketing 190 collected data for running more refined experiments, e.g., by data discovery service 132 in FIG. 4B. In this example prior to, or while, new data is made available to potential data consumers, disseminating data takes a proactive approach, which begins preliminary processing with low resolution simulation 192. The data discovery service 132 evaluates an initial execution plan 194 and estimate required resources based on that low resolution simulation 192 in combination with collected human parameters 196 and historical simulation data 198. The human parameters 196, e.g., from previously collected historical data or provided interactively, may include time to collect approvals required from project leaders, technicians and administrative personnel, for example.

Based on experiments 196 in the queue and the estimation of execution times, the data discovery service 132 determines whether the simulations will be completed by a given deadline and publishes 200 the results. These results 200 may indicate what further data may be required for running refined simulations, but that may be unavailable due to limited computing capacity. The data discovery service 132 also publishes 202 data that local organizations are expected to have ready by a given deadline, e.g., the selling agent 104S, 106S, 108S places an ask for selling the produced data. This provides other organizations with an opportunity to leverage those datasets. Next, the data discovery service 132 starts executing 204 queued simulations in a simulation batch.

For an expedited offer, the simulation/experiment may or may not have reached some milestone at a point prior to the deadline, such that, at the milestone the simulation may not have enough time to complete by the deadline. So, if at that time the simulation milestone has not occurred and some required results (i.e., data) have not yet been produced 206, additional resources may be dedicated to the simulation/experiment. A buying agent 104B, 106B, 108B can place an expedited ask to other organizations for acquiring needed data 208. After acquiring data 208, if the simulation is still incomplete 210, simulation 204 continues until it is complete 206. Once the simulation has produced the required results (i.e., the simulation is complete 206, 210) simulation ends 212.

Optionally, instead of higher resolution simulation 204-210 for refining the data, other parameters may be adjusted. For example, the data discovery service 132 may adjust the number of simulation rounds necessary to increase confidence in results; adjust the allowed degree of overlap in data gathered from multiple organizations; and/or adjust the number of identifiable critical areas in simulated areas, e.g., based on traffic conditions, flooding and energy consumption.

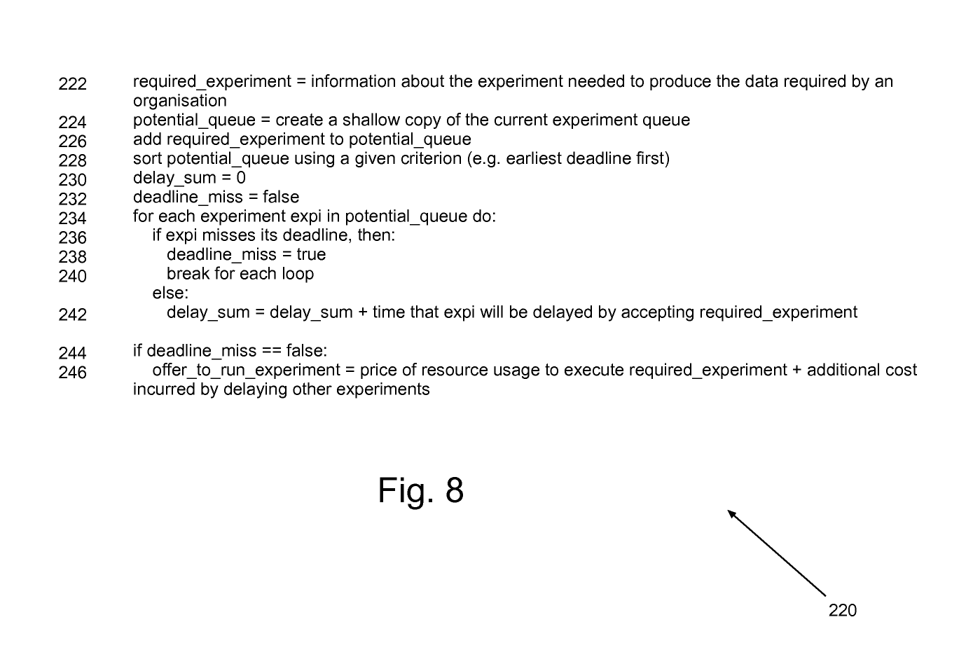

FIG. 8 shows an example of pseudo-code for selectively adjusting 220 the experiment queue based on the urgency of acquiring the data that other organizations may give to certain experiments and data in the queue. In this example, a selling agent for an organization offers, e.g., places asks, to execute experiments for other organizations, provided local experiments still meet deadlines. After collecting 222 the requirements for the other experiment/simulation (i.e., information needed to conduct the experiment/simulation), a shallow copy is made 224 of the current queue. Then, the collected requirements are added 226 to the simulation queue. The queue is sorted 228, a cumulative delay variable and a deadline variable are initialized 230, 232. Then, the queued experiments/simulations are checked 234 in sort order. If a simulation/experiment misses its deadline 236, the deadline variable is set to true 238 and checking stops 240. Otherwise, any delay to previously projected completion is added 242 to the cumulative delay variable and checking continues until the end of the queue. If no deadlines are missed 244, i.e., the accumulated delay has not delayed anything to the point of missing a deadline, then the cost of executing the added experiment is determined 246 and an offer (an ask) is placed.

Thus advantageously, the present invention provides a market based data sharing mechanism to assist in discovery and cost sharing, and optimizes production especially of geography specific data and emergency data. Each local organization can sell and acquire data automatically based on organizational needs and the importance of the data to the organization. Further, needs of an organization may be determined automatically based on several factors including geography, execution time of preliminary experiments to generate the data from scratch, and deadline for consuming the data. Moreover, as the data value changes over time, experiments may be refined to identify what data is important for timely performing the experiments.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A data distribution system comprising:
one or more computers sharing resources with organizations in a plurality of locations;
an auction marketplace provisioned in said one or more computers;
at least one selling agent supporting one or more organizations in each location, said selling agent placing offers to sell selected organizational data in said auction marketplace;
at least one buying agent supporting one or more organizations in said each location, said buying agent selectively placing bids responsive to said offers to sell data and; and
a data discovery service provisioned in said one or more computers, said data discovery service identifying potential buyers of organizational data and notifying respective buying agents of data available from other organizations.

2. A data distribution system as in claim 1, wherein said at least one selling agent incudes a selling agent for each organization in each location.

3. A data distribution system as in claim 1, wherein said data discovery service lists identified said potential buyers for each instance of available organizational data offered by each said selling agent.

4. A data distribution system as in claim 1, wherein said auction marketplace comprises an auctioneer notifying listed said potential buyers of available organizational data.

5. A data distribution system as in claim 1, wherein said at least one buying agent includes a buying agent for each organization in each location.

6. A data distribution system as in claim 1, wherein each buying agent determines whether a respective local organization has an interest in offered data from another organization and the data value to said respective local organization, said buying agent posting an offer to buy said offered data responsive to said data value.

7. A data distribution system as in claim 6, wherein said each buying agent determines the cost of generating said offered data by said respective local organization, said cost being said data value to said respective local organization.

8. A data distribution system as in claim 6, wherein said auction marketplace comprises an auctioneer selectively accepting offers to buy.

9. A data distribution system as in claim 1, wherein said organizational data is geographically specific data for one or more of said plurality of locations.

10. A data distribution method comprising:
collecting data about a location, said location being one of a plurality of locations, each having one or more local organizations sharing resources on one or more computers;
identifying marketable data from said data collected;
offering said marketable data in an auction marketplace provisioned in said one or more computers;
identifying any of said local organizations having a potential interest in offered said data;
notifying identified said local organizations of said offered data; and
receiving bids for said offered data from one or more of said identified local organizations.

11. A data distribution method as in claim 10, after notifying said identified local organizations said method further comprising:
determining a minimum benefit for purchasing said offered data;
determining a cost to generate said offered data locally;
adjusting said cost for an expected time lapse between purchase and use; and
sending a bid whenever an expected benefit for said bid exceeds said minimum benefit.

12. A data distribution method as in claim 11, wherein a buying agent for each of said identified local organizations determines said bid and whether to send said bid.

13. A data distribution method as in claim 10, wherein notifying local organizations comprises:
preliminarily processing said data;
evaluating preliminary processing results to determine an expected processing completion time;
notifying identified said local organizations of said expected processing completion time;
notifying identified said local organizations of data other organizations are expected to have completed by said expected processing completion time; and
continuing processing said data.

14. A data distribution method as in claim 10, wherein a data discovery service provisioned in said one or more computers identifies any local organization having a potential interest and an auction marketplace provisioned in said one or more computers notifies identified said any local organization and receives said bids, said method further comprising said auction marketplace selecting a winning bid.

15. A data distribution method as in claim 14, wherein notifying local organizations comprises said data discovery service:
preliminarily processing said data; and
evaluating preliminary processing results to determine an expected processing completion time.

16. A data distribution method as in claim 15, wherein said auction marketplace includes an auctioneer, and notifying local organizations further comprises said auctioneer:
notifying identified said local organizations of said expected processing completion time;
notifying identified said local organizations of data other organizations are expected to have completed by said expected processing completion time; and
said data discovery service continuing processing said data.

17. A data distribution method as in claim 16, wherein said data is geographical data about said locations, processing comprises processing simulated local conditions in a respective said location from said data and continuing processing comprises:
queuing simulation with said data in a simulation queue; and
executing queued simulations in queued order until a deadline for execution passes or all simulations are complete.

18. A computer program product for location data sharing and distribution, said computer program product comprising a computer usable medium having computer readable program code stored thereon, said computer readable program code comprising:
computer readable program code means for an auction marketplace;
computer readable program code means for a selling agent for organizations in each location of a plurality of locations, each said selling agent placing offers to sell selected organizational data in said auction marketplace;
computer readable program code means for a buying agent for said organizations in one or more organizations, said buying agent selectively placing bids responsive to said offers to sell data and; and
computer readable program code means for a data discovery service identifying potential buyers of organizational data and notifying respective buying agents of data available from other organizations.

19. A computer program product for location data sharing and distribution as in claim 18, wherein said computer readable program code means for said data discovery service includes computer readable program code means for listing identified said potential buyers for each instance of available organizational data offered by each said selling agent; and said computer readable program code means for said auction marketplace comprises computer readable program code means for an auctioneer notifying listed said potential buyers of available organizational data.

20. A computer program product for location data sharing and distribution as in claim 18, wherein said computer readable program code means for said selling agent provides a selling agent for each organization in each location, said computer readable program code means for said buying agent provides a buying agent for each organization in each location, and each said buying agent comprises computer readable program code means for determining whether a respective local organization has an interest in offered data from another organization and the data value to said respective local organization, and computer readable program code means for posting an offer to buy said offered data responsive to said data value.

21. A computer program product for location data sharing and distribution as in claim 18, wherein said location data is environmental condition data for a respective location, said data discovery service and said auction marketplace are provisioned on cloud computers, and said organizations are cloud clients in geographical locations, at least two of said locations having areas affected by the same environmental conditions.

22. A computer program product for location data sharing and distribution, said computer program product comprising a computer usable medium having computer readable program code stored thereon, said computer readable program code causing a plurality of computers executing said code to:
collect data about a location, said location being one of a plurality of locations, each having one or more local organizations sharing computer resources;
identify marketable data from said data collected;
offer said marketable data in an auction marketplace provisioned in said computers;
identify any of said local organizations having a potential interest in offered said data;
notify identified said local organizations of said offered data; and
receive bids for said offered data from one or more of said identified local organizations.

23. A computer program product for location data sharing and distribution as in claim 22, after notifying said identified local organizations said computer readable program code further causing said plurality of computers executing said code to:
determine a minimum benefit for purchasing said offered data;
determine a cost to generate said offered data locally;
adjust said cost for an expected time lapse between purchase and use; and
send a bid whenever an expected benefit for said bid exceeds said minimum benefit.

24. A computer program product for location data sharing and distribution as in claim 22, wherein said computer readable program code causing said plurality of computers to notify local organizations, further causes said plurality of computers to:
process said data preliminarily;
evaluate preliminary processing results to determine an expected processing completion time;
notify identified said local organizations of said expected processing completion time;
notify identified said local organizations of data other organizations are expected to have completed by said expected processing completion time; and
continuing processing said data.

25. A computer program product for location data sharing and distribution as in claim 24, wherein said plurality of computers are cloud computers, said organizations are cloud clients in geographical locations, and location data is environmental condition data for a respective location, said computer readable program code further causing said plurality of computers executing said code to provision on cloud computers a data discovery service processing data and identifying local organizations with potential interest in data and an auction marketplace sending notifications and receiving offers and bids, and at least two of said locations have areas affected by the same environmental conditions.
